(19) United States
(12) Patent Application Publication
(10) Pub. No.: US 2021/0289113 A1
(43) Pub. Date: Sep. 16, 2021

(54) SYSTEM AND PROCESS FOR IDENTIFICATION AND ILLUMINATION OF ANATOMICAL SITES OF A PERSON AND ARTICLES AT SUCH SITES

(71) Applicant: AI GASPAR LIMITED, Hong Kong (CN)

(72) Inventors: Wai Keung YEUNG, Hong Kong (CN); Wai Pik LAU, Hong Kong (CN); Chik Yun Ian KWAN, Hong Kong (CN); Pui Hang KO, Hong Kong (CN); Wing Chiu LIU, Hong Kong (CN); Man Chuen TSE, Hong Kong (CN)

(73) Assignee: AI GASPAR LIMITED, Hong Kong (CN)

(21) Appl. No.: 17/277,567

(22) PCT Filed: Sep. 18, 2019
(86) PCT No.: PCT/CN2019/106523

§ 371 Date: Mar. 18, 2021

(30) Foreign Application Priority Data
Sep. 18, 2018 (HK) 18111994.3
Nov. 15, 2018 (HK) 18114656.6

(51) Int. Cl. H04N 5/225; G06T 7/55; G06K 9/00; G06K 9/20

(52) U.S. Cl. CPC H04N 5/2256; G06T 7/55; G06T 2207/30196; G06K 9/00302; G06K 9/2027; G06K 9/00255

(57) ABSTRACT

A computerized system (100, 200) for illuminating an article (280, 307, 308) on an anatomic site (305, 306) of a subject (270) includes: an optical image acquisition device (130, 230) for acquiring an optical image of a subject (270); a processor module (110, 210) operably in communication with the optical image acquisition device (130, 230) for receiving an image input signal (135) therefrom; and one or more light sources (150, 252, 254) operably in communication with the processor module (110, 210) for illuminating an anatomical site (305, 306) of the subject (270). One or more light sources (150, 252, 254) are controllably moveable by the processor module (110, 210), which sends a control signal (155) in conjunction with the image input signal (135) to one or more light sources (150, 252, 254), so as maintains illumination on the anatomical site (305, 306) of the subject (270) irrespective of movement of the subject (270).

### TECHNICAL FIELD

The present invention relates to a system and process for identification and illumination of anatomical sites of a person, as well as the articles at such sites.

### BACKGROUND OF THE INVENTION

The display of wearable articles may be, at a point of sale, such as in a display cabinet or a display tray.

In some sales environments, display of wearable articles may be by way of a manikin so as to give a display of the article with in an anatomical position and with reference to the anatomical site at which the wearable article is worn, to a customer.

Further, in some sales environment, a customer may wear a wearable article on the customer's own body, in order to give a customer a more realistic visual appearance as to how the article appears when worn and whether it is considered compatible with the customer's mental perception as to whether the article is appropriately aesthetically pleasing and thus whether to purchase the article.

Often one or mirrors are provided for the customer to view the worn article at different angles, so as to provide more comprehensive views and perspective.

Alternatively, in a sales or display environment, a wearable article may be worn and displayed by a modelling person, such as in the fashion industry, for consideration by customers or other types of consumers.

### Objection of the Invention

It is an object of the present invention to provide a system and process to identify and illuminate the anatomical sites of a person and articles at such sites, which overcomes or ameliorates at least some deficiencies as associated with the prior art.

### SUMMARY OF THE INVENTION

In a first aspect, the present invention provides a computerized system for illuminating an article on an anatomic site on a subject, the computerized system including an optical image acquisition device for acquiring an optical image of a subject; a processor module operably in communication with the optical image acquisition device and for receiving an image input signal therefrom; and one or more light sources operably in communication with the processor module and for illuminating an anatomical site of said subject, wherein said one or more light sources are controllably moveable by the processor; wherein the processor sends a control signal to said one or more light sources and in conjunction with the image input signal, so as maintains said illumination on said anatomical site of said subject irrespective of movement of the subject.

The system may determine the distance between the subject and the optical acquisition device by the distance sensor operably in communication with said processor; by using a further optical image acquisition device, with a dominant offset to the optical image acquisition device and the depth information is calculated by analyzing the difference between the images captured; or by use of a further optical image acquisition device positioned directly on top or on the optical image acquisition device, whereby the distance between the subject and the first optical image acquisition device is obtained by measuring the number of pixel therebetween.

The processor may determine the article by way of analysis with a database of images of articles and associated data thereof. The processor determines said article by way of artificial intelligence (AI).

The processor may determine the anatomical position on the subject to provide illumination, by way of anatomical recognition. The anatomical recognition may be by way of facial recognition.

The system may utilise optical recognition of facial expressions, so as to ascertain the appeal by a subject in relation to said article.

In a second aspect, the present invention provides a process operable using a computerized system for controlling the illuminating an article on an anatomic site on a subject, the computerized system including an optical image acquisition device, a processor module and one or more light sources, said process including the steps of:
obtaining an optical image of a subject using optical image acquisition device; and
sending a control signal to said one or more light sources and in conjunction with the image input signal, so as maintains said illumination on said anatomical site of said subject irrespective of movement of the subject.

### BRIEF DESCRIPTION OF THE DRAWINGS

In order that a more precise understanding of the above-recited invention can be obtained, a more particular description of the invention briefly described above will be rendered by reference to specific embodiments thereof that are illustrated in the appended drawings.

FIG. 1 shows a schematic representation of the system according to the present invention;

FIG. 2a shows a perspective view of a system of the present invention having camera, depth sensor, light sources with actuators and mirror in a first embodiment of the present invention.

FIG. 2b shows a top view of the system of FIG. 2a;

FIG. 2c shows a side view of the system of FIG. 2a and FIG. 2b;

FIG. 3a shows a schematic representation of anatomic detection in a further embodiment of the invention and shows an estimation of a necklace location by comparing the detected face with a standard scaling template;

FIG. 3b shows a face of a person detected according to the embodiment with reference to FIG. 3a;

FIG. 4a shows the relationship between detected object location and required actuator motion; and

FIG. 4b shows a derivation of inverse kinematics relationship.

### DETAILED DESCRIPTION OF THE DRAWINGS

The present invention provides for the illumination of wearable article on the body of a user or an article held by user, and is useful for both a customer as well as for market intelligence by a retailer as to the responsiveness and reception of a customer when wearing such an article.

In implementation of the system and process of the present invention, a customer wears wearable articles, of holds an article, and optionally stands in front of a mirror or other visual display unit with such an article.

The jewellery, which may be one or more pieces of jewellery, or other articles worn on the customer or articles held by a customer, are highlighted by one or more spotlights from the system.

The system detects the location of the article worn on the customer or held by the customer, and controls the positioning of illumination of the spotlights so as to trace and illuminate the article even if the customer is moving around and changing position.

Articles for Illumination

Examples of such wearable articles include articles of jewellery such as finger rings, earrings, necklaces, bracelets, bangles. Other articles may include watches and timepieces.

Alternatively, other applicable wearable articles may include articles of clothing or accessories that are worn by a person.

Further, articles to be held by a customer may be any such article which is optically identifiable, such as a mobile phone of the like.

Article Detection

In preferred embodiment of the present invention, the article may be identified by way of an Artificial Intelligence (AI) system: An example of such an AI system is “You only look once (YOLO)”, which is a state-of-the-art, real-time object detection system. It is currently free of charge, and allows for ease of tradeoff between speed and accuracy simply by changing the size of the model, with no retraining being required. As will be understood, other trained AI engines or Neural Networks could also be used.

The AI system is trained with thousands of facial images so that the system is able to detect customer's face, his/her facial expression and identify age group and gender.

The system can identify whether a customer is happy or not with product by detecting the smiling level, or other types of facial expression indicative of mood response to a stimuli.

Once faces of a person are identified by the AI system in an image, the faces are then overlaid by rectangles, and such rectangles seek to bound the boundaries of the face images.

The coordinates of the rectangles, as well as other identified information, such as the age, gender, emotion and coordinates of face features such as eyes, ears, mouth, nose, etc. can be output to a text file.

An AI engine, which may be the same or another AI engine, that was trained with thousands of article or product images so that the system is able to detect the brand, type, style, colour, size, and other related properties of the same kinds of articles or products can be used.

The system supports multiple article of object detection. Once articles or objects are identified by the AI system in an image, the objects are then overlaid by rectangles.

The rectangles try to bound the boundaries of the object. The coordinates of the rectangles, as well as other identified information, such as the brand, type, style, colour, size, and other related properties, are output to a text file.

System Configuration

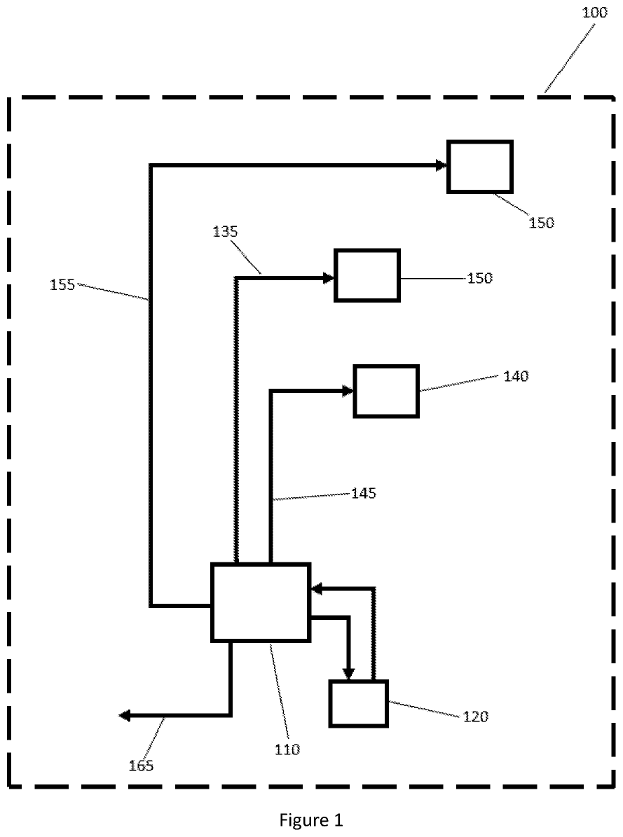

Referring to FIG. 1, an embodiment of the system 100 of the present invention is shown which comprises a processor 110, a data store 120, an optical image acquisition device 130, optionally one or more depth or distance sensors 140 and one or more light sources 150.

Optionally, as shown in subsequent embodiments, the system may further include a mirror, which may be a normal or one-way mirror.

In a broad form of the invention, the image acquisition device 130 detects an image of a person in an Area of Interest (AOI) which sends a signal 135 of the person to the processor.

The depth or distance sensor 140, or other process or method examples of which are given below, determines the distance of the person or an anatomical site of a person from a datum, and sends a signal 145 indicative of the position to the processor 110.

The processor 100 sends a control signal 155 to the light source, which includes both a light signal for the type and level of illumination as well as an actuation signal to direct the illumination from the light source to a requisite position or anatomical location of the person, which may be varied in real time, as the direction of the light source 150 may be varied to track to the person.

The data store 120 optionally allows for storage of data against which comparison between acquired images and pre-existing images is conducted. This may also be an AI type module or the like.

Output data may be acquired from output signal 165, such as information about the article, reaction of the customer via facial expressions, duration of wearing or articles or the like.

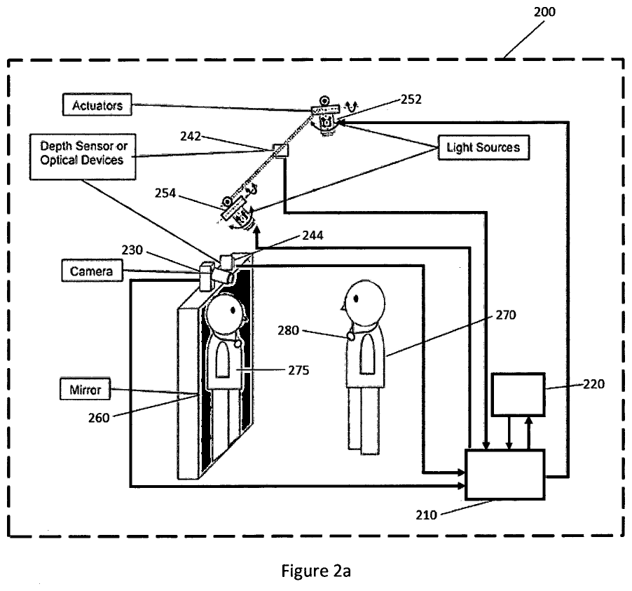

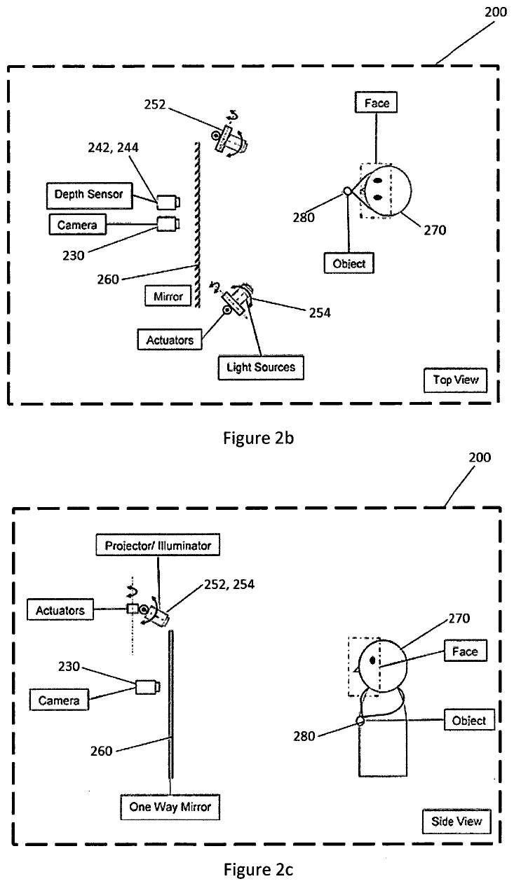

Referring now to FIGS. 2a, 2b and 2c, a first embodiment of the system 200 of the present invention is shown, having a processor 210, a data store 220, an optical image acquisition device 230 as a camera such as a CCD camera, two depth or distance sensors 240, 244 and two light sources 252, 254.

The camera 230 is set up so that it captures images of the Area of Interest (AOI) in front of a mirror 260 for subsequent face of the person or customer 270 and object 280 detection.

In order to determine the reference position of the customer in the system so that the light sources can be appropriately shined on the article, a frame of reference is required, and for convenience in the present embodiment which includes the optional mirror 260, the distance between the customer 270 and the mirror 260, one of the following by way of example may be used:
Using an auxiliary camera, with a dominant offset to the main camera, and the depth information can be calculated by analyzing the difference between the images captured.
Another configuration is to set an extra camera directly on top or on the side of the existing camera. The distance between the customer and the mirror can obtained by measuring the number of pixel between them.
Using depth or distance sensor, such as infrared depth sensor, to measure the distance.

As will be understood, multiple light sources 252, 254 with multiple colour temperatures may installed. By using different combinations of light sources, the following can be achieved:
Construct desired lighting atmosphere.
Allocate most suitable colour temperature light source to illuminate the article, for example corresponding jewellery. For example, gold is better illuminated with yellow light while diamond may be better illuminated with white light.

Each light source 252, 254 may can be set to ON or OFF individually, and each light source 252, 254 is mounted with actuators, for example two rotary actuators, for controlling its horizontal and vertical pointing angle.

If the customer wears multiple articles of jewellery, at least one light source 252, 254 may be allocated to point to each jewellery. As an example, if the customer wears both necklace and ring, two light sources may be arranged so as to point to the necklace and another light source to point to the ring.

The mirror 260 may be normal mirror, or one-way mirror.

In case of normal mirror 260, the camera 230 is required so as not to interfere, for example the camera 230 may be mounted above the mirror 260.

In case of single-way mirror 260, the camera 230 may be hidden behind the mirror 260. Preferably the camera 230 is hidden behind a single-way mirror 260 around eye-level, it is because face detection is most accurate at this angle.

Article Detection

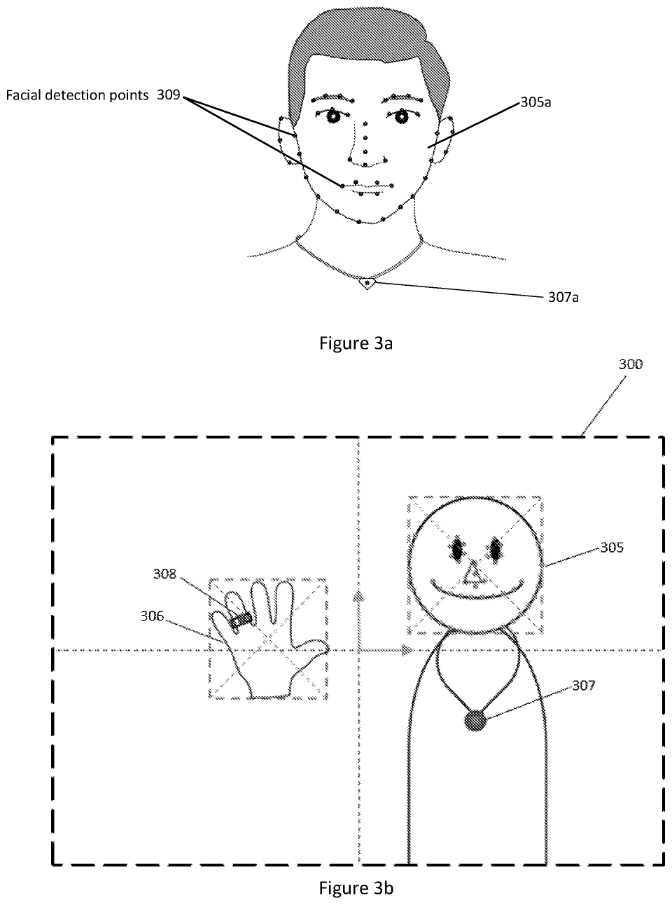

The AI system is then applied to detect if any trained objects appear in the real-time video stream obtained via the main camera as shown in FIG. 3a. Facial detection points 309 at the periphery of specific features such as the ears, the eyes and the mouth of a human face 305a are located by the AI system.

The jewellery location may be detected directly with the AI engine trained with jewellery article or product, for example the necklace 307a in FIG. 3a.

As an alternative, as shown in FIG. 3b, the jewellery location may be estimated by detecting human face 305 and hand 306. In the case of a necklace 307, once a human face 305 is detected, a rectangle bounding the face is formed. The location of necklace 307 can be calculated by comparing the rectangle with a standard scaling facial template.

For the case of a ring 308, the location of ring may be replaced by hand 306 location.

Depending on accuracy of the AI engine and noise in the images, the output coordinates of identified articles or objects may be fluctuating or missing in short occasions. Application of 2D invariant Kalman filter may smoothen the noise an inaccuracy so that the output coordinates is stable even if the original data is fluctuating.

Projective Mapping and Inverse Kinematics Calculation

Projective mapping and inverse kinematics calculation may be used to compensate misalignment between the camera 230 and the light source 252, 254 actuators and to relate the coordinates of the article 280 or object detected in the camera 230 image to the required destination coordinates of the light source 252, 254 actuators.

A calibration process is necessary to generate a projective transformation matrix. The matrix relates the coordinates in pixel of four calibration points appearing in the camera 230 image to four corresponding reference actuator coordinates.

First of all, the actuator is moved by fine command adjustment to a position where the spot light is overlapping with the centre of the camera 230 image. This actuator position is set to be the reference value.

The actuator is then commanded to move fixed angles in both negative and positive directions and in both horizontal and vertical directions. This forms a rectangle.

The coordinates of the four corners of the rectangle A, B, C and D in pixel in the camera image are then related to the four corners A′, B′, C′ and D′ of the spotlight/light source actuator coordinates.

Defining the transformation of coordinates by these equations:

$${x}_{{K}^{′}} = \frac{{v}_{1} {x}_{K} + {v}_{2} {y}_{K} + {v}_{3}}{{v}_{7} {x}_{K} + {v}_{8} {y}_{K} + 1} \\ {y}_{{K}^{′}} = \frac{{v}_{4} {x}_{K} + {v}_{5} {y}_{K} + {v}_{6}}{{v}_{7} {x}_{K} + {v}_{8} {y}_{K} + 1}$$

where

(x_{K}, y_{K}) are the coordinates of a point in pixel in the camera image and

(x_{K′}, y_{K′}) are the coordinates of the corresponding actuator position.

In matrix form,

$$[ \begin{matrix}{x}_{K o} \\ {y}_{K o} \\ w\end{matrix} ] = [ \begin{matrix}{v}_{1} & {v}_{2} & {v}_{3} \\ {v}_{4} & {v}_{5} & {v}_{6} \\ {v}_{7} & {v}_{8} & 1\end{matrix} ] [ \begin{matrix}{x}_{K} \\ {y}_{K} \\ 1\end{matrix} ] \\ [ \begin{matrix}{x}_{{K}^{′}} \\ {y}_{{K}^{′}}\end{matrix} ] = [ \begin{matrix}{x}_{K o} \\ {y}_{K o}\end{matrix} ] / w$$

Consider mapping of all 4 corners (A,B,C,D) to (A′, B′, C′, D′)

$$[ \begin{matrix}{x}_{{A}^{′}} \\ {y}_{{A}^{′}} \\ {x}_{{B}^{′}} \\ {y}_{{B}^{′}} \\ {x}_{{C}^{′}} \\ {y}_{{C}^{′}} \\ {x}_{{D}^{′}} \\ {y}_{{D}^{′}}\end{matrix} ] = [ \begin{matrix}{x}_{A} & {y}_{A} & 1 & 0 & 0 & 0 & - {x}_{A} {x}_{{A}^{′}} & - {y}_{A} {x}_{{A}^{′}} \\ 0 & 0 & 0 & {x}_{A} & {y}_{A} & 1 & - {x}_{A} {y}_{{A}^{′}} & - {y}_{A} {y}_{{A}^{′}} \\ {x}_{B} & {y}_{B} & 1 & 0 & 0 & 0 & - {x}_{B} {x}_{{B}^{′}} & - {y}_{B} {x}_{{B}^{′}} \\ 0 & 0 & 0 & {x}_{B} & {y}_{B} & 1 & - {x}_{B} {y}_{{B}^{′}} & - {y}_{B} {y}_{{B}^{′}} \\ {x}_{C} & {y}_{C} & 1 & 0 & 0 & 0 & - {x}_{C} {x}_{{C}^{′}} & - {y}_{C} {x}_{{C}^{′}} \\ 0 & 0 & 0 & {x}_{C} & {y}_{C} & 1 & - {x}_{C} {y}_{{C}^{′}} & - {y}_{C} {y}_{{C}^{′}} \\ {x}_{D} & {y}_{D} & 1 & 0 & 0 & 0 & - {x}_{D} {x}_{{D}^{′}} & - {y}_{D} {x}_{{D}^{′}} \\ 0 & 0 & 0 & {x}_{D} & {y}_{D} & 1 & - {x}_{D} {y}_{{D}^{′}} & - {y}_{D} {y}_{{D}^{′}}\end{matrix} ] [ \begin{matrix}{v}_{1} \\ {v}_{2} \\ {v}_{3} \\ {v}_{4} \\ {v}_{5} \\ {v}_{6} \\ {v}_{7} \\ {v}_{8}\end{matrix} ]$$

The coefficients of the transformation matrix can then be obtained by solving the 8 simultaneous equations.

$$[ \begin{matrix}{v}_{1} \\ {v}_{2} \\ {v}_{3} \\ {v}_{4} \\ {v}_{5} \\ {v}_{6} \\ {v}_{7} \\ {v}_{8}\end{matrix} ] = {[ \begin{matrix}{x}_{A} & {y}_{A} & 1 & 0 & 0 & 0 & - {x}_{A} {x}_{{A}^{′}} & - {y}_{A} {x}_{{A}^{′}} \\ 0 & 0 & 0 & {x}_{A} & {y}_{A} & 1 & - {x}_{A} {y}_{{A}^{′}} & - {y}_{A} {y}_{{A}^{′}} \\ {x}_{B} & {y}_{B} & 1 & 0 & 0 & 0 & - {x}_{B} {x}_{{B}^{′}} & - {y}_{B} {x}_{{B}^{′}} \\ 0 & 0 & 0 & {x}_{B} & {y}_{B} & 1 & - {x}_{B} {y}_{{B}^{′}} & - {y}_{B} {y}_{{B}^{′}} \\ {x}_{C} & {y}_{C} & 1 & 0 & 0 & 0 & - {x}_{C} {x}_{{C}^{′}} & - {y}_{C} {x}_{{C}^{′}} \\ 0 & 0 & 0 & {x}_{C} & {y}_{C} & 1 & - {x}_{C} {y}_{{C}^{′}} & - {y}_{C} {y}_{{C}^{′}} \\ {x}_{D} & {y}_{D} & 1 & 0 & 0 & 0 & - {x}_{D} {x}_{{D}^{′}} & - {y}_{D} {x}_{{D}^{′}} \\ 0 & 0 & 0 & {x}_{D} & {y}_{D} & 1 & - {x}_{D} {y}_{{D}^{′}} & - {y}_{D} {y}_{{D}^{′}}\end{matrix} ]}^{- 1} [ \begin{matrix}{x}_{{A}^{′}} \\ {y}_{{A}^{′}} \\ {x}_{{B}^{′}} \\ {y}_{{B}^{′}} \\ {x}_{{C}^{′}} \\ {y}_{{C}^{′}} \\ {x}_{{D}^{′}} \\ {y}_{{D}^{′}}\end{matrix} ]$$

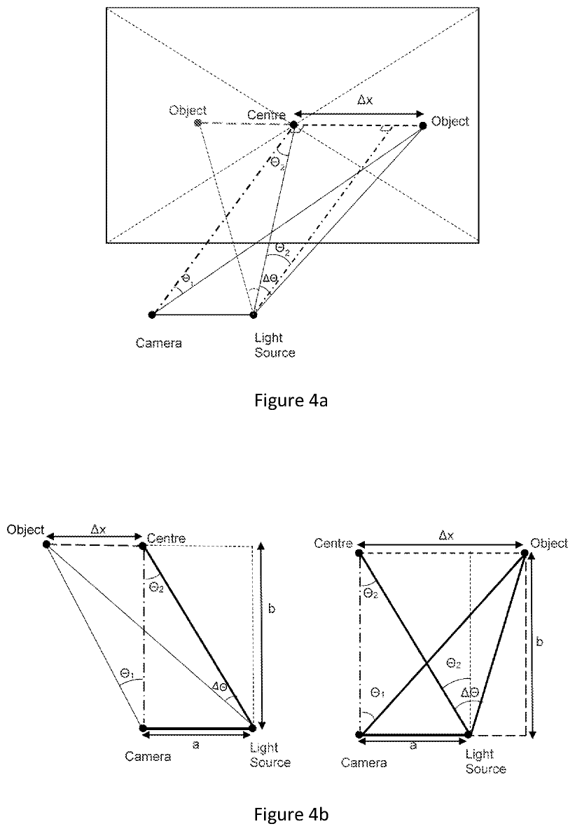

The relationship between the distance in pixel in the camera image Δx and the corresponding actuator position Δθ is shown in FIG. 4b. This relationship is nonlinear.

Relationship Between Detected Object Location and Required Actuator Motion.

Assuming the offset between the camera and light source be a and the distance between the mirror and the object be b as shown in FIG. 8, the inverse kinematics relationship between the required actuator position Δθ and the distance between the object and the centre of the camera image Δx can be derived as

Δθ=tan⁻¹(tan θ₂−kx)+θ₂

Where:

k is a coefficient that can be obtained through calibration, tuning, or measurement and calculation.

θ₂ is a coefficient depending on the offset between the camera and light source be a and the distance between the mirror and the object be b.

Calibration of two separate inverse kinematic formula for both horizontal and vertical directions are required.

A motion control algorithm is written move the spotlights to trace the motion of the objects interactively.

The system further includes a user interface, and operators may, for example, customize the following in the software interface:
Turning ON and OFF of individual spot light
Select specific colour of spotlights
Select lighting intensity
Select what jewellery detection is ON. For example, we can select only spotlights/light sources on a necklace is enabled even if the customers both necklace and a ring at the same time.

The system may record or output numerous data, for example record the customer's behavior, such as age and gender, emotion via facial expressions or aural representations when assessing a particular article or product, preference categories, hot items and the like, all of which may be used in sales analytics.

This can also help retailers to track or monitor a consumer or potential customer's shopping behavior, their interest level and appeal towards particular product or item

1. A computerized system for illuminating an article on an anatomic site on a subject, the computerized system including: an optical image acquisition device for acquiring an optical image of a subject; a processor module operably in communication with the optical image acquisition device and for receiving an image input signal therefrom; and one or more light sources operably in communication with the processor module and for illuminating an anatomical site of said subject, wherein said one or more light sources are controllably moveable by the processor; wherein the processor sends a control signal to said one or more light sources and in conjunction with the image input signal, so as maintains said illumination on said anatomical site of said subject irrespective of movement of the subject.

2. The computerized system according to claim 1, wherein the system determines the distance between the subject and the optical acquisition device by the distance sensor operably in communication with said processor.

3. The computerized system according to claim 1, wherein the system determines the distance between the subject and the optical acquisition device by using a further optical image acquisition device, with a dominant offset to the optical image acquisition device and the depth information is calculated by analyzing the difference between the images captured.

4. The computerized system according to claim 1, wherein the system determines the distance between the subject and the optical acquisition device by use of a further optical image acquisition device positioned directly on top or on the optical image acquisition device, whereby the distance between the subject and the first optical image acquisition device is obtained by measuring the number of pixel therebetween.

5. The computerized system according to claim 1, wherein the processor determines said article by way of analysis with a database of images of articles and associated data thereof.

6. The computerized system according to claim 1, wherein the processor determines said article by way of artificial intelligence (AI).

7. The computerized system according to claim 1, wherein the processor determines the anatomical position on the subject to provide illumination, by way of anatomical recognition.

8. The system according to claim 7, wherein said anatomical recognition is by way of facial recognition.

9. The system according to claim 1, wherein the system utilises optical recognition of facial expressions, so as to ascertain the appeal by a subject in relation to said article.

10. A process operable using a computerized system for controlling the illuminating an article on an anatomic site on a subject, the computerized system including an optical image acquisition device, a processor module and one or more light sources, said process including the steps of: obtaining an optical image of a subject using optical image acquisition device; and sending a control signal to said one or more light sources and in conjunction with the image input signal, so as maintains said illumination on said anatomical site of said subject irrespective of movement of the subject.
